(19) United States
(12) Patent Application Publication
(10) Pub. No.: US 2016/0101609 A1
(43) Pub. Date: Apr. 14, 2016

(54) Methods for Bonding Structures With Adhesive in Electronic Devices

(71) Applicant: Apple Inc., Cupertino, CA (US)

(72) Inventors: Cyrus Y. Liu, Cupertino, CA (US); Der-Song Lin, Cupertino, CA (US); Kuo-Hua Sung, San Jose, CA (US)

(21) Appl. No.: 14/538,221

(22) Filed: Nov. 11, 2014

Related U.S. Application Data
(60) Provisional application No. 62/062,659, filed on Oct. 10, 2014.

(51) Int. Cl. B32B 37/12; B32B 38/00

(52) U.S. Cl. CPC B32B 37/12; B32B 38/00; B32B 37/1292; B32B 2037/1253; B32B 2038/0076; B32B 2457/00

(57) ABSTRACT

An electronic device may have display layers and other structures. A layer of liquid adhesive may be patterned onto a structure. The liquid adhesive may be pre-cured to increase the viscosity of the liquid adhesive and to partially shrink the liquid adhesive. The structure to which the liquid adhesive has been applied may be laminated to another structure. During lamination, the pre-cured liquid adhesive may be compressed between the structures that are being laminated. The adhesive may then be fully cured to bond the structures together. The thickening of the liquid adhesive during pre-curing helps control the spread of the adhesive. The shrinking of the liquid adhesive helps prevent stresses from developing that could lead to visible stress-induced artifacts following curing.

This application claims the benefit of provisional patent application No. 62/062,659, filed Oct. 10, 2014, which is hereby incorporated by reference herein in its entirety.

### BACKGROUND

This relates generally to electronic devices, and more particularly, to bonding electronic device structures with adhesive.

Electronic devices often include components that are bonded together using adhesive. For example, a display may have layers that are laminated together using liquid adhesive. Challenges can arise in forming bonds using liquid adhesive. If an adhesive is too viscous, it can be difficult to spread the adhesive adequately during lamination. If an adhesive is too thin, it may be difficult or impossible to adequately control the shape of the adhesive boundary as the layers are pressed together. Curing operations tend to shrink liquid adhesives, which can lead to stresses that create undesired visible artifacts on the layers that are being bonded.

In view of these challenges, it would be desirable to be able to provide improved techniques for forming adhesive bonds between structures in an electronic device.

### SUMMARY

An electronic device may have structures that are bonded using adhesive. The structures may include display structures such as liquid crystal display layers, a display cover layer, layers in an organic light-emitting diode display, a touch sensor layer, and other display layers. The structures to be bonded may also be parts of components, a housing, or other device structures.

A layer of liquid adhesive may be patterned onto a structure that is to be bonded. The liquid adhesive may be pre-cured to thicken and partially shrink the liquid adhesive. The structure to which the liquid adhesive has been applied may be pressed against another structure. For example, layers of material may be laminated using a roller lamination tool or a lamination press. During lamination, the pre-cured liquid adhesive may be compressed between the structures that are being laminated to each other.

Following lamination, the pre-cured adhesive may be fully cured to bond the structures together. The thickening of the liquid adhesive that is achieved during pre-curing may help control the spread of the adhesive during lamination and can prevent irregular adhesive borders from developing. The shrinking of the liquid adhesive that is achieved during pre-curing can help prevent stresses from developing that could lead to visible stress-induced artifacts when the adhesive is cured.

### BRIEF DESCRIPTION OF THE DRAWINGS

FIG. 1 is a perspective view of an illustrative electronic device such as a laptop computer in accordance with an embodiment.

FIG. 2 is a perspective view of an illustrative electronic device such as a handheld electronic device in accordance with an embodiment.

FIG. 3 is a perspective view of an illustrative electronic device such as a tablet computer in accordance with an embodiment.

FIG. 4 is a perspective view of an illustrative electronic device such as a computer display in accordance with an embodiment.

FIG. 5 is a cross-sectional side view of an illustrative electronic device with a display in accordance with an embodiment.

FIG. 6 is a top view of an illustrative display layer that has been coated with a patterned adhesive layer in accordance with an embodiment.

FIG. 7 is diagram showing equipment and operations associated with assembling structures such as display layers or other planar layers of material using adhesive in accordance with an embodiment.

FIG. 8 is a flow chart of illustrative steps involved in assembling electronic device structures using adhesive in accordance with an embodiment.

### DETAILED DESCRIPTION

Electronic devices may include structures that are bonded together using adhesive. The structures that are bonded together may include layers in a display module, a display cover glass layer, a touch sensor layer, other planar layers of material, electrical components, mounting brackets, housing structures, and other electronic device structures. Configurations in which display components such as liquid crystal display layers, organic light-emitting diode display layers, touch sensor layers, and other display layers are being bonded together are sometimes described herein as an example. This is, however, merely illustrative. Any suitable structures may be bonded together with adhesive, if desired.

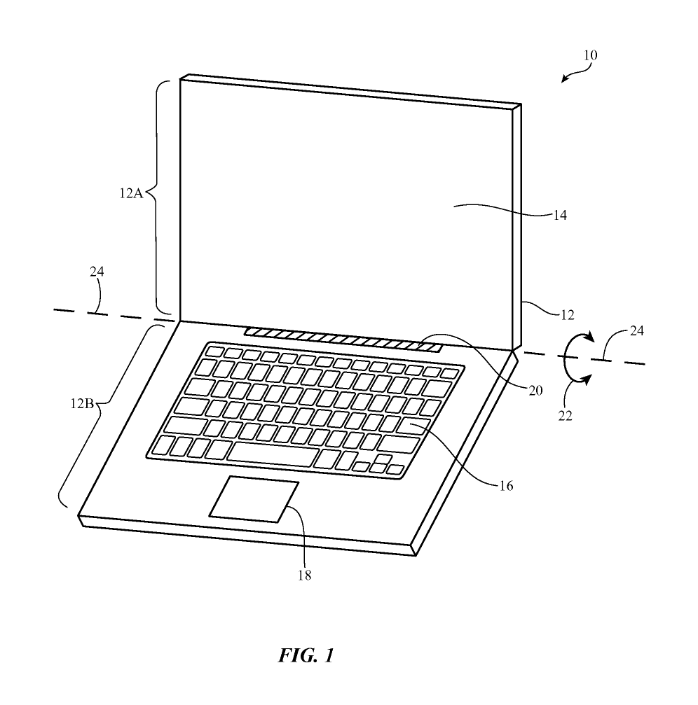

Illustrative electronic devices that may be provided with displays and other structures that are bonded using adhesive are shown in FIGS. 1, 2, 3, and 4.

Illustrative electronic device 10 of FIG. 1 has the shape of a laptop computer having upper housing 12A and lower housing 12B with components such as keyboard 16 and touchpad 18. Device 10 may have hinge structures 20 that allow upper housing 12A to rotate in directions 22 about rotational axis 24 relative to lower housing 12B. Display 14 may be mounted in upper housing 12A. Upper housing 12A, which may sometimes be referred to as a display housing or lid, may be placed in a closed position by rotating upper housing 12A towards lower housing 12B about rotational axis 24.

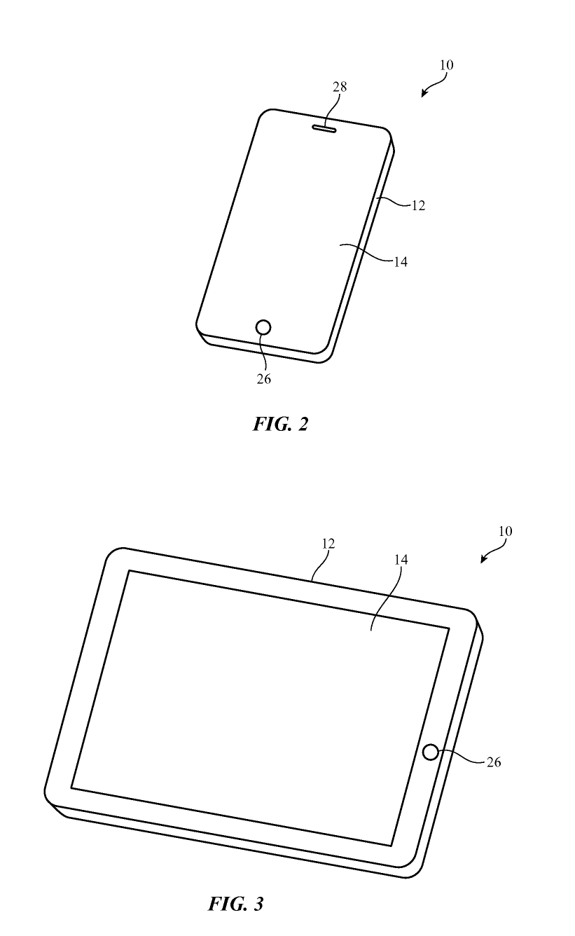

FIG. 2 shows how electronic device 10 may be a handheld device such as a cellular telephone, music player, gaming device, navigation unit, or other compact device. In this type of configuration for device 10, housing 12 may have opposing front and rear surfaces. Display 14 may be mounted on a front face of housing 12. Display 14 may, if desired, have openings for components such as button 26. Openings may also be formed in display 14 to accommodate a speaker port (see, e.g., speaker port 28 of FIG. 2).

FIG. 3 shows how electronic device 10 may be a tablet computer. In electronic device 10 of FIG. 3, housing 12 may have opposing planar front and rear surfaces. Display 14 may be mounted on the front surface of housing 12. As shown in FIG. 3, display 14 may have an opening to accommodate button 26 (as an example).

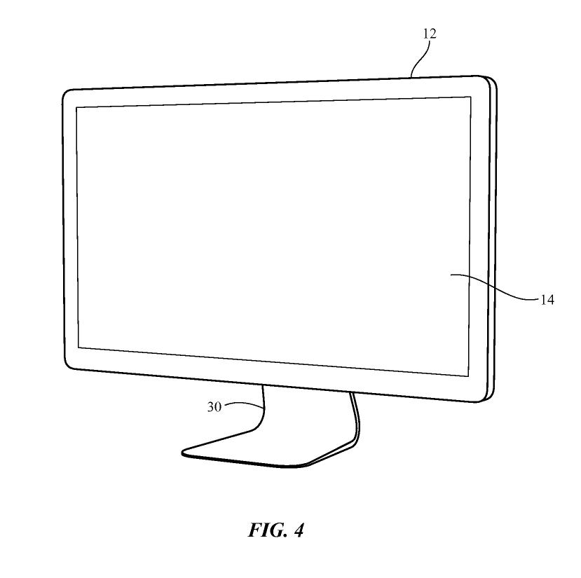

FIG. 4 shows how electronic device 10 may be a computer display, a computer that has been integrated into a computer display, or a display for other electronic equipment. With this type of arrangement, housing 12 for device 10 may be mounted on a support structure such as stand 30 or stand 30 may be omitted (e.g., stand 30 can be omitted when mounting device 10 on a wall). Display 14 may be mounted on a front face of housing 12.

The illustrative configurations for device 10 that are shown in FIGS. 1, 2, 3, and 4 are merely illustrative. In general, electronic device 10 may be a laptop computer, a computer monitor containing an embedded computer, a tablet computer, a cellular telephone, a media player, or other handheld or portable electronic device, a smaller device such as a wrist-watch device, a pendant device, a headphone or earpiece device, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment.

Housing 12 of device 10, which is sometimes referred to as a case, may be formed of materials such as plastic, glass, ceramics, carbon-fiber composites and other fiber-based composites, metal (e.g., machined aluminum, stainless steel, or other metals), other materials, or a combination of these materials. Device 10 may be formed using a unibody construction in which most or all of housing 12 is formed from a single structural element (e.g., a piece of machined metal or a piece of molded plastic) or may be formed from multiple housing structures (e.g., outer housing structures that have been mounted to internal frame elements, metal midplate members, or other internal housing structures).

Display 14 may be a touch sensitive display that includes a touch sensor or may be insensitive to touch. A touch sensor for display 14 may be formed from an array of capacitive touch sensor electrodes, a resistive touch array, touch sensor structures based on acoustic touch, optical touch, or force-based touch technologies, or other suitable touch sensor components. The touch sensor electrodes may be mounted on a touch sensor substrate that is separate from the other layers in a display or touch sensor electrodes may be integrated onto a common substrate with pixel structures and other display structures. Display 14 for device 10 may be a liquid crystal display, an organic light-emitting diode display, an electrophoretic display, or a display formed using other display technologies.

A display cover layer may cover the surface of display 14 or a display layer such as a color filter layer, thin-film transistor layer, or other portion of a display may be used as the outermost (or nearly outermost) layer in display 14. The outermost display layer may be formed from a transparent glass substrate, a clear plastic layer, or other transparent substrate member.

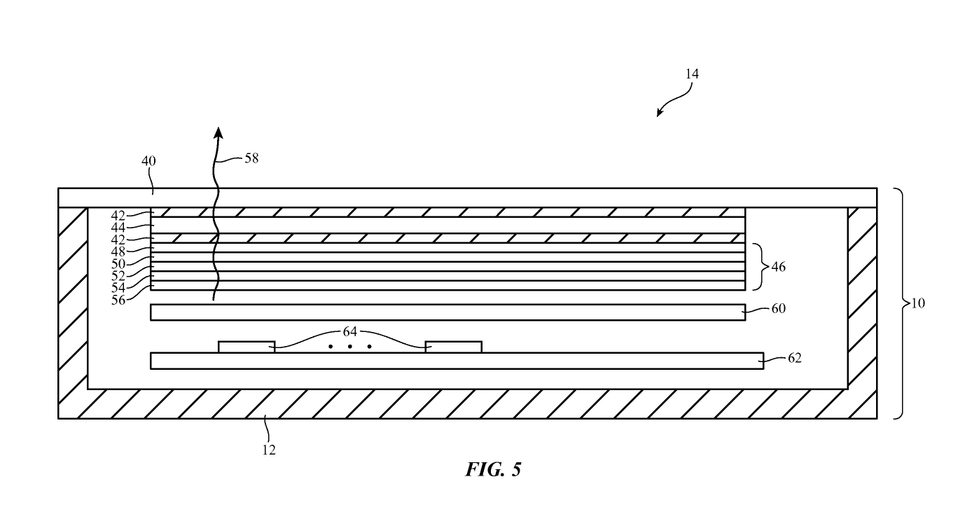

A cross-sectional side view of an illustrative electronic device that includes a display is shown in FIG. 5. As shown in FIG. 5, device 10 may have a display such as display 14. Display 14 may be a touch screen display that has a touch sensor such as touch sensor 44 that overlaps display layers 46. Touch sensor 44 may include a layer of conductive capacitive touch sensor electrodes or other touch sensor components (e.g., resistive touch sensor components, acoustic touch sensor components, force-based touch sensor components, light-based touch sensor components, etc.). Capacitive touch screen electrodes may be formed from an array of indium tin oxide pads or other transparent conductive structures on a substrate that is separate from display layers 46 (e.g., touch sensor 44 may be a stand-alone touch panel) or the structures of touch sensor 44 may be integrated with display structures in display layers 46.

Display layers 46 may form a display module or other display structures for a liquid crystal display, an organic light-emitting diode display, a plasma display, an electrophoretic display, or other suitable type of display. With one illustrative configuration, display layers 46 may form a liquid crystal display and may include upper polarizer 48 and lower polarizer 56. A layer of liquid crystal material 52 may be sandwiched between layers 50 and 54. Layer 50 may be a color filter layer and layer 54 may be a thin-film transistor layer or layer 54 may be a color filter layer and layer 50 may be a thin-film transistor layer. Configurations in which layer 50 or layer 54 include both thin-film transistor structures and color filter structures may also be used.

Backlight unit 60 may emit light such as light 58 to provide backlight illumination for display 14. Backlight 58 may pass through the transparent layers of display module 46 (e.g. layers 48, 50, 52, 54, and 56) and through the transparent indium tin oxide touch sensor electrodes or other transparent structures of touch sensor 44 for viewing by a user of device 10. During operation, display module 46 may create images for viewing by the user.

In addition to display module 46, device 10 may include electrical components 64.

Components 64 may be mounted to printed circuits such as printed circuit 62 within the interior of housing 12. Printed circuit 62 may be a rigid printed circuit board (e.g., a printed circuit board formed from fiberglass-filled epoxy or other rigid printed circuit board material) or may be a flexible printed circuit (e.g., a printed circuit formed from a sheet of polyimide or other flexible polymer layer). Patterned metal traces within printed circuit board 24 may be used to form signal paths between components 64. Components 64 may include integrated circuits, sensors, audio components, radio-frequency components, communications circuits, input-output devices, light-emitting components, and other electrical devices.

Adhesive may be used in attaching structures in device 10 together. For example, adhesive may be used in coupling display cover layer 40 to housing 12, may be used in attaching parts of housing 12 and/or internal device structures together, and may be used in joining portions of electrical components in device 10 together. As shown in the example of FIG. 5, layers of adhesive such as adhesive layers 42 may, if desired, be used in bonding together layers in display 14. For example, touch sensor 44 may be attached to the lower surface of display cover layer 40 using a layer of adhesive 42 and display module 46 may be attached to the lower surface of touch sensor 44 using adhesive 42.

In environments of the type shown in FIG. 5, light 58 passes through transparent layers of material associated with touch screen display 14, so it is desirable for adhesive layers 42 to exhibit good optical clarity. Optically clear adhesives for forming layers 42 may be based on optically clear liquid adhesives such as liquid acrylic adhesives, liquid silicone adhesives, liquid urethane adhesives, and liquid epoxy adhesives. Other types of liquid adhesive (e.g., other polymers) may be used in forming layers 42 if desired. The use of optically clear liquid adhesives is sometimes described herein as an example.

To eliminate air bubbles, a roller lamination tool or a lamination press (e.g., a vacuum lamination press or a lamination press without a vacuum) may be used in laminating layers of display 14 together using adhesive 42. If the liquid adhesive that is being compressed between the layers of the display or other structures is too thin (i.e., if the viscosity of the adhesive is too low), the liquid adhesive may spread out unevenly (i.e., the liquid adhesive may spread into a shape that has an irregular border). If the liquid adhesive is too thick (i.e., too viscous), it may be difficult to properly spread the adhesive over a desired area. Challenges such as these that are related to the ability to control the placement and spread of the liquid adhesive can make it difficult to pattern the adhesive in desired shapes.

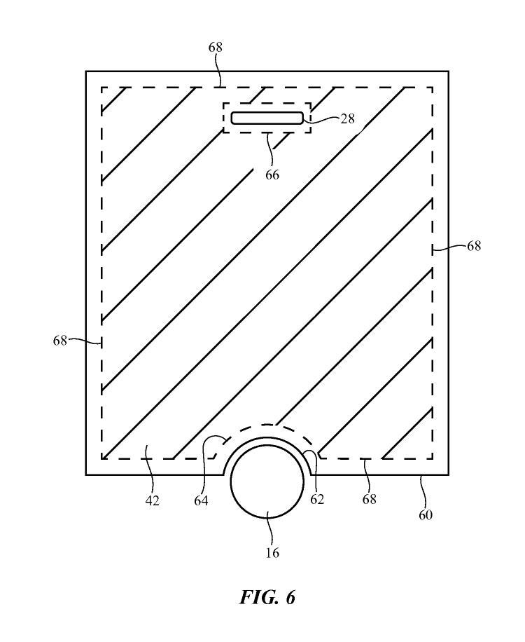

Consider, as an example, the illustrative shape of adhesive 42 of FIG. 6. In the example of FIG. 6, display layer 60 (e.g., one of display layers 46) has a rectangular outline. Adhesive 42 may be patterned with a matching rectangular outline of slightly smaller dimensions (outline 68). Notch 62 may be formed in layer 60 to accommodate button 16. To ensure that adhesive 42 does not extend over button 16, adhesive 42 may be patterned so that edge 64 of adhesive 42 conforms to the semicircular shape of notch 62. To avoid overlapping with speaker opening 28, adhesive 42 may be patterned so that there is no adhesive 42 within region 66 around speaker 28. As this example demonstrates, it may be desirable to deposit adhesive 42 with shapes that have detailed features (e.g., notch-shaped edges, exclusion zones, edges that are aligned with the edges of a display layer, etc.).

In situations of the type shown in the example of FIG. 6 and other situations in which adhesive is to be evenly applied with a well-defined border shape, it may be desirable to pre-cure the liquid adhesive prior to lamination. The adhesive may be applied when it is thin, but may be thickened due to the cross-links formed by pre-curing. When the adhesive is thin, it will be able to satisfactorily cover the parts to be bonded. The thickening (increased viscosity) of the adhesive that is achieved during pre-curing helps define the border of the adhesive and helps control the spread of the adhesive during lamination. The pre-curing process also shrinks the adhesive, which reduces stresses between the bonded layers following final adhesive curing operations. This can help ensure that visible stress-induced artifacts are not present on a display or other sensitive components being bonded together.

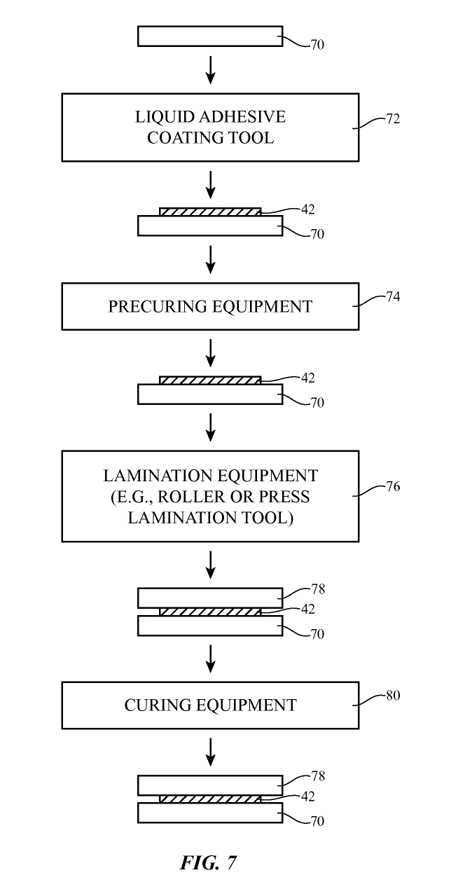

Illustrative equipment and operations involved in using this type of adhesive application technique in bonding display layers or other structures for device 10 are shown in FIG. 7. Initially, a structure to be bonded such as structure 70 is coated with a liquid adhesive precursor (i.e., uncured liquid adhesive) using liquid adhesive coating tool 72. Structure 70 may be a display cover layer, a display layer, a touch sensor layer, another planar layer of material, or other structure in device 10. Tool 72 may include slit coating equipment, screen printing equipment, stencil printing equipment, or other adhesive deposition equipment. Using equipment 72, an uncured layer of adhesive 42 may be deposited on the surface of structures 70 with a desired pattern.

Following the patterning of an uncured layer of adhesive 42 onto structure 70, adhesive pre-curing equipment 74 may be used to pre-cure the adhesive 42. Equipment 74 may include a light source such as a lamp, light-emitting diode, or laser that emits light. The emitted light may be ultraviolet light, visible light, or other light that induces cross-linking in the liquid adhesive. Equipment 74 may also include a heat source for promoting cross-linking in the adhesive. If desired, equipment 74 may include equipment for dispensing a chemical catalyst to promote curing of the liquid adhesive. The liquid adhesive is preferably only partly cured using equipment 74. For example, the adhesive that is subjected to light curing, heat curing, or catalyst curing may be characterized by at least 50% cross-linking, at least 60% cross-linking, etc. The adhesive is preferably not completely cross-linked (i.e., cross-linking is preferably less than about 95%, less than 85%, or less than 70% after treatment with pre-curing equipment 74 (as examples). This allows the adhesive to spread and flow sufficiently during lamination to coat the surfaces to be bonded.

Lamination equipment 76 may be used to attach a structure such as structure 78 to structure 70. Structure 78 may be a display cover layer, a display layer, a touch sensor layer, or other structure in device 10. Equipment 76 may include a roller lamination tool (e.g., roller lamination equipment without a vacuum), may be a lamination press (with our without a vacuum), or may be other suitable lamination equipment for pressing together structures to be bonded and thereby compressing adhesive 42 between these structures.

As shown in FIG. 7, equipment 76 presses structures 78 and 70 together, so that they are joined using adhesive 42.

Following attachment of structure 78 and 70 using pre-cured adhesive 42, curing equipment 80 may be used to cure adhesive 42 and thereby bond structure 78 to structure 70. Curing equipment 80 may be a light source such as a lamp, light-emitting diode, or laser that emits light to fully cure adhesive 42. The emitted light may be ultraviolet light, visible light, or other light. Equipment 80 may also include a heat source for curing adhesive 42. Other types of curing equipment may also be used (e.g., catalyst dispensing equipment, etc.).

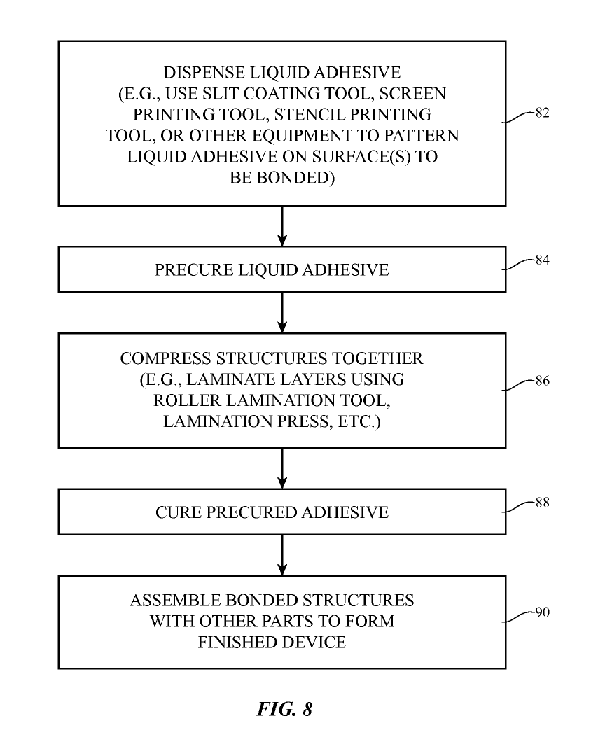

Illustrative steps involved in assembling structures for device 10 using liquid adhesive are shown in FIG. 8. At step 82, liquid adhesive (e.g., a liquid polymer precursor material) may be deposited in a layer with a desired pattern on a structure to be bonded. The structure may be a display cover layer, a display layer (e.g., a polarizer, a thin-film transistor layer, a color filter layer, a clear glass or polymer layer, etc.) or other structure in device 10. The liquid adhesive may be deposited in a desired pattern using liquid adhesive coating tool 72 (FIG. 7).

At step 84, pre-curing equipment 74 may be used to pre-cure the deposited liquid adhesive. The pre-curing process preferably does not fully cure the adhesive (i.e., the adhesive is cross-linked less than 100% so that the adhesive remains tacky and able to form a bond with an additional display layer, touch sensor layer, display cover layer, or other device structure). As an example, the initially uncured liquid adhesive may exhibit less than 10% cross linking The pre-cured adhesive may be cross-linked by between 50% and 95%, may be cross-linked by 50% or more, may be cross-linked by 60% or more, or may be cross-linked by other suitable amounts.

The pre-curing process (i.e., the process of applying light, heat, and or catalyst in sufficient quantity to promote partial cross-linking without fully curing the adhesive) may thicken and shrink the deposited adhesive. Increasing the viscosity of the adhesive may prevent the adhesive from flowing in an undesired pattern during lamination. Shrinking the adhesive may reduce the amount of stress that is induced between the layers that are being bonded during subsequent curing operations.

At step 86, after the adhesive layer has been pre-cured, an additional structure may be attached to the structure to which the adhesive was deposited. The additional structure may include a structure such as a display cover layer, a display layer, a touch sensor layer, a layer that includes display and touch sensor structures, a clear glass or plastic layer, another planar layer of material, or other structure in device 10. Equipment such as equipment 76 (e.g. lamination equipment or other equipment that presses structures together) may be used to press the additional structure against the structure to which the adhesive was deposited and pre-cured (e.g., a display layer or other planar layer of material, etc.). This compresses the pre-cured adhesive between the structure and the additional structure. If desired, adhesive may be applied to both of the surfaces that are to be joined and may be pre-cured on both of these surfaces prior to attachment with equipment 76.

At step 88, the adhesive that is interposed between the laminated structures and that has been compressed between the laminated structures may be cured by application of heat, light, and/or catalyst, thereby bonding the laminated structures together with adhesive 42. The curing operations of step 88 may be used to more fully cross-link the polymer in adhesive 42 (e.g., the cross-linking process may be completed so that adhesive 42 is completely cured and is fully or nearly fully cross-linked such as being cross-linked by more than 75%, more than 80%, more than 90%, etc.).

The foregoing is merely illustrative and various modifications can be made by those skilled in the art without departing from the scope and spirit of the described embodiments. The foregoing embodiments may be implemented individually or in any combination.

What is claimed is:

1. A method, comprising:
applying liquid adhesive to a first structure;
pre-curing the liquid adhesive to thicken and shrink the liquid adhesive;
compressing the pre-cured liquid adhesive between the first structure and a second structure; and
curing the pre-cured liquid adhesive to bond the first structure to the second structure.

2. The method defined in claim 1 wherein applying the adhesive to the first structure comprises applying the adhesive to a display cover layer.

3. The method defined in claim 1 wherein applying the adhesive to the first structure comprises applying the adhesive to a display layer.

4. The method defined in claim 1 wherein applying the adhesive to the first structure comprises applying the adhesive to a polarizer layer.

5. The method defined in claim 1 wherein applying the adhesive to the first structure comprises applying the adhesive to a touch sensor.

6. The method defined in claim 1 wherein applying the adhesive comprises applying the adhesive using a slit coating tool.

7. The method defined in claim 1 wherein applying the adhesive comprises applying the adhesive using a screen printing tool.

8. The method defined in claim 1 wherein applying the adhesive comprises applying the adhesive using a stencil printing tool.

9. The method defined in claim 1 wherein pre-curing the adhesive comprises applying heat to the liquid adhesive to cross-link the adhesive by at least 50%.

10. The method defined in claim 1 wherein pre-curing the adhesive comprises applying ultraviolet light to the liquid adhesive to cross-link the adhesive by at least 50%.

11. The method defined in claim 1 wherein pre-curing the adhesive comprises applying catalyst to the liquid adhesive to cross-link the adhesive by at least 50%.

12. The method defined in claim 1 wherein pre-curing the adhesive comprises pre-curing the adhesive using a technique selected from the group consisting of: heat curing, light curing, and catalyst curing, wherein curing the adhesive comprises curing the adhesive using a technique selected from the group consisting of: heat curing, light curing, and catalyst curing, and wherein the pre-curing technique is different than the curing technique.

13. The method defined in claim 1 wherein curing the adhesive comprises curing the adhesive by applying ultraviolet light to the adhesive.

14. The method defined in claim 1 wherein compressing the pre-cured liquid adhesive between the first structure and the second structure comprises compressing the first and second structures together using a lamination press.

15. The method defined in claim 1 wherein compressing the pre-cured liquid adhesive between the first structure and the second structure comprises compressing the first and second structures together using a vacuum lamination press.

16. The method defined in claim 1 wherein compressing the pre-cured liquid adhesive between the first structure and the second structure comprises compressing the first and second structures together using a roller lamination tool.

17. A method for forming a display, comprising:
applying a patterned layer of liquid adhesive to a first layer of the display;
pre-curing the liquid adhesive to thicken and shrink the liquid adhesive;
laminating the first layer of the display to a second layer of the display with the pre-cured liquid adhesive; and
curing the pre-cured liquid adhesive to bond the first display layer to the second display layer.

18. The method defined in claim 17 wherein pre-curing the liquid adhesive comprises forming at least 50% cross-linking in the liquid adhesive.

19. A method, comprising:
patterning a layer of liquid adhesive onto a first planar electronic device structure;
pre-curing the patterned layer of liquid adhesive to thicken and shrink the liquid adhesive;
laminating the first planar structure to a second planar electronic device structure by compressing the pre-cured liquid adhesive between the first planar electronic device structure and the second planar electronic device structure; and
bonding the first planar electronic device structure to the second planar electronic device structure by curing the pre-cured liquid adhesive.

20. The method defined in claim 19 wherein pre-curing the liquid adhesive comprises pre-curing the liquid adhesive until the liquid adhesive is at least 50% cross-linked and wherein bonding the first planar structure to the second planar structure comprises curing the pre-cured liquid adhesive until the liquid adhesive is at least 80% cross-linked.
